(19) United States
(12) Patent Application Publication
(10) Pub. No.: US 2012/0072268 A1
(43) Pub. Date: Mar. 22, 2012

(54) REPUTATION SYSTEM TO EVALUATE WORK

(75) Inventors: Jordan Ritter, San Francisco, CA (US); Alexander Edelstein, San Francisco, CA (US)

(73) Assignee: SERVIO, INC., San Francisco, CA (US)

(21) Appl. No.: 13/239,223

(22) Filed: Sep. 21, 2011

Related U.S. Application Data
(60) Provisional application No. 61/403,834, filed on Sep. 21, 2010.

(51) Int. Cl. G06Q 10/06

(52) U.S. Cl. 705/7.39

(57) ABSTRACT

A reputation system to evaluate work is disclosed. Answer data for each of one or more unsupervised workers is received. The answer data includes one or more answers each representing a judgment by the worker that reflects on the quality of a given work product. The reputation system determines programmatically, based at least in part on a reputation data of an owner of the work product, the answer data, and a respective reputation data of the respective unsupervised workers, which answers are correct.

CROSS REFERENCE TO OTHER APPLICATIONS

This application claims priority to U.S. Provisional Patent Application No. 61/403,834 entitled OUTSOURCING TASKS VIA A NETWORK filed Sep. 21, 2010 which is incorporated herein by reference for all purposes.

### BACKGROUND OF THE INVENTION

Online “crowdsourcing” services enable work requestors to access a flexible and potentially large pool of unsupervised human workers. The Mechanical Turk crowdsourcing marketplace service offered by Amazon.com, Inc. is an example (see www.mturk.com). To date, such services typically have been used to recruit unsupervised online human workers to perform relatively low skill and/or repetitive tasks that a human is considered to be better than a computer or other machine at performing. Examples include editing written content, rating a website or other web-based content, and identifying duplicative content.

Typical services do not provide effective mechanisms to ensure the quality, accuracy, etc. of the specific work product produced in response to a particular task. In the case of Mechanical Turk, for example, a requestor's recourse if a task is not performed to the requestor's satisfaction is to refuse payment. Some attempts have been made to identify and ban workers who game the system and/or do not do good work. Statistical methods, such as statistical classifiers, have been used to determine which of a plurality of individual, separate responses to the same task are correct. But typically no reliable mechanism is provided to ensure that work produced by a particular worker in response to a specific task request satisfies applicable acceptance criteria.

### BRIEF DESCRIPTION OF THE DRAWINGS

Various embodiments of the invention are disclosed in the following detailed description and the accompanying drawings.

FIG. 1 is a block diagram illustrating an embodiment of a system to outsource work.

FIG. 2 is a flow diagram illustrating an embodiment of a process to outsource work.

FIG. 3 is a flow diagram illustrating an embodiment of a process to outsource tasks.

FIG. 4 is a block diagram illustrating an embodiment of a work completion system.

FIG. 5 is a block diagram illustrating an embodiment of a reputation system to evaluate work.

FIG. 6 is a flow diagram illustrating an embodiment of a process to evaluate work.

FIG. 7 is a flow diagram illustrating an embodiment of a process to evaluate quality.

FIG. 8 is a flow diagram illustrating an embodiment of a process to evaluate work.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A reputation system to evaluate work quality is disclosed. In various embodiments, answer data for each of one or more workers is received. The answer data includes one or more answers, each representing a judgment by the worker that reflects on the quality of a given work product. The reputation system determines, based at least in part on reputation data of an owner of the work product, the answer data, and reputation data of the workers who provided the answer data, which answers are correct. The determination is used, in some embodiments along with other information, to decide whether the work product satisfies applicable acceptance criteria. In some embodiments, adjustments to the respective reputations of the workers and/or the work product owner are generated based at least in part on the determination of which answers are correct.

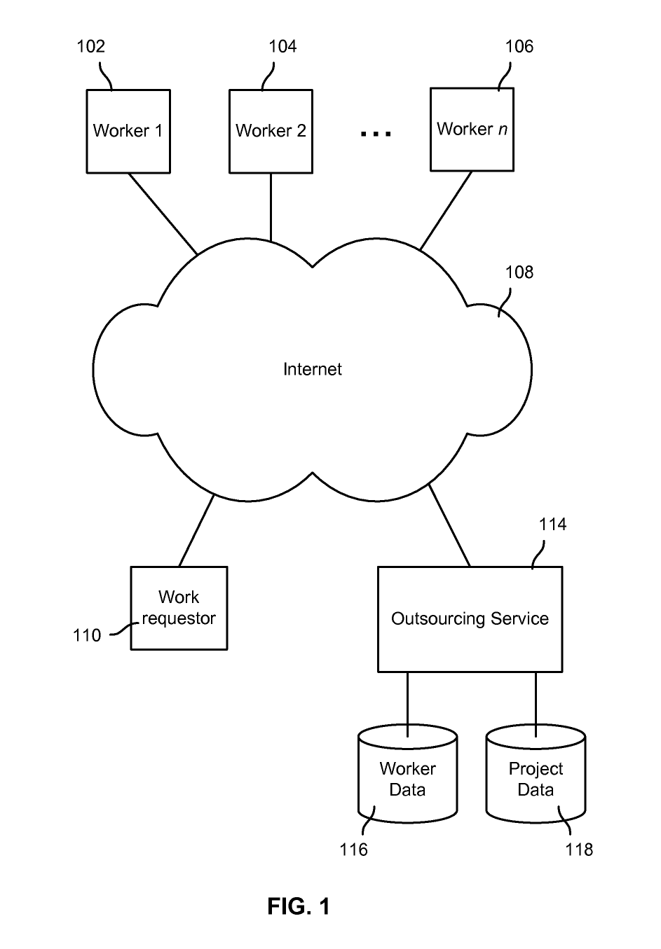

FIG. 1 is a block diagram illustrating an embodiment of a system to outsource work. In the example shown, Internet users associated with worker client systems 1 to n, represented in FIG. 1 by worker client systems 102, 104, and 106, have access to the Internet 108. Similarly, work requestors, represented in FIG. 1 by work requestor client system 110, are connected to the Internet 108. In the example shown, an outsourcing service 114 is connected to the Internet 108. Service 114 maintains data on registered outsource workers in a worker database 116 and maintains in a project data store 118 task and business process flow data related to work that work requestors have requested to be performed. In various embodiments, service 114 uses project data 118 to define and post discrete tasks to be performed by outsource workers. A task in various embodiments may be any discrete work item to be performed. Examples of worker user interfaces include web interfaces provided by the service 114 via a service-operated web page and worker interfaces provided via a social network application. Workers associated with clients such as 102, 104, and 106 browse available tasks via the worker interface and, if they find a task they are interested in performing, select the task and perform the associated work as instructed. If the work is accepted, the worker is paid, in some embodiments immediately via a micropayment, for the work.

A work request may be submitted by a work requestor. For example, a user associated with work requestor client system 110 may request that work be performed, such as a request to proofread a blog entry before the user posts the entry. In some embodiments, a widget or other tool is provided via a blog entry creation interface to enable an “edit” of the entry (or other text) to be requested, for example by clicking on an “edit” button. In other embodiments, a tools menu such as a pull down or popup menu includes an option to “edit” content. Automatically on selection of the “edit” option, the text in question and a request to edit the request is generated and sent to the service 114. A business process flow instance is created to manage performance of the work. Depending on the amount of text and how the business process and/or service 114 are configured, the text may be broken into subparts, for example paragraphs, sentences, or other parts, and for each subpart a task defined and posted to edit that part. Once all the component tasks have been completed, the work done by the various workers who completed the tasks is combined to generate and deliver to the work requestor an edited version of the original text.

In some embodiments, a work requestor such as one associated with work requestor client system 110 uses a work request interface, such as a graphical user interface, a web services interface, and/or an API, to request that work be performed. As in the example above, the service 114 creates an instance of a business process flow to manage performance of the work through completion. The business process flow invokes a work completion platform to cause required work to be performed. The work completion platform instantiates its own workflow to manage completion of the required work, the result of which is returned to the crowdsourcing service business process flow, which assembles and delivers the final work product to the work requestor, initiates payment by the work requestor, etc. The business process flow and/or the work completion workflow or both may enter a wait state while a component flow or sub-flow executes. Upon completion of execution of the component flow or sub-flow, processing at the next level up in the workflow resumes. Multiple component flows and/or processes may in some cases execute in parallel. A first workflow may invoke a second workflow which may invoke a third workflow, and so on, to any arbitrary depth as may be required to perform work required to produce a final work output of the overall business process flow.

Automatically obtaining a review of work to determine whether the work meets acceptance criteria is disclosed. Upon completion of a task by an originating worker, in various embodiments one or more review tasks are generated automatically, to be performed by one or more reviewing workers from a set of unsupervised, remote workers. In some embodiments, to originating worker is a member of the set of unsupervised, remote workers. In some embodiments, an original task has a review task counterpart usable to determine whether the original work satisfies acceptance criteria. For example, an original task to write a headline for an article or other content may have an associated review task to determine, given the content and the headline provided by the original task performer, whether the headline fits the content. Based at least in part on the input received from one or more reviewers, a decision is made programmatically whether the work performed by the originating worker satisfies applicable acceptance criteria. If so, the work is accepted and the originating worker and reviewers who agreed the work met acceptance criteria are paid. If not, the work is caused to be redone by another worker, and so on, until the work has been completed in a manner that meets acceptance criteria.

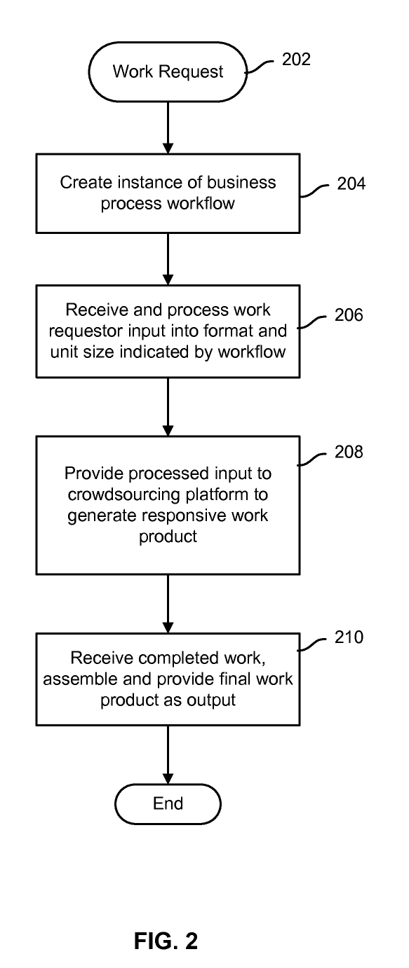

FIG. 2 is a flow diagram illustrating an embodiment of a process to outsource work. In various embodiments, the process of FIG. 2 is implemented by a work-requestor facing interface and service of an online outsourcing service such as service 114 of FIG. 1. In the example shown, on receiving a work request (202) an instance of a business process flow configured to manage completion of the requested work is created (204). For example, a business process template is created in some embodiments by persons knowledgeable about a type of work request desired to be supported. The template defines discrete tasks and how attributes of those tasks are to be determined at runtime, for example by associating input data provided by a requestor (or portions thereof) with specific work to be done. An instance of the business process manages performance of a particular work request from start to finish, including by invoking a work completion platform to cause specific tasks to be performed by members of the outsource labor pool.

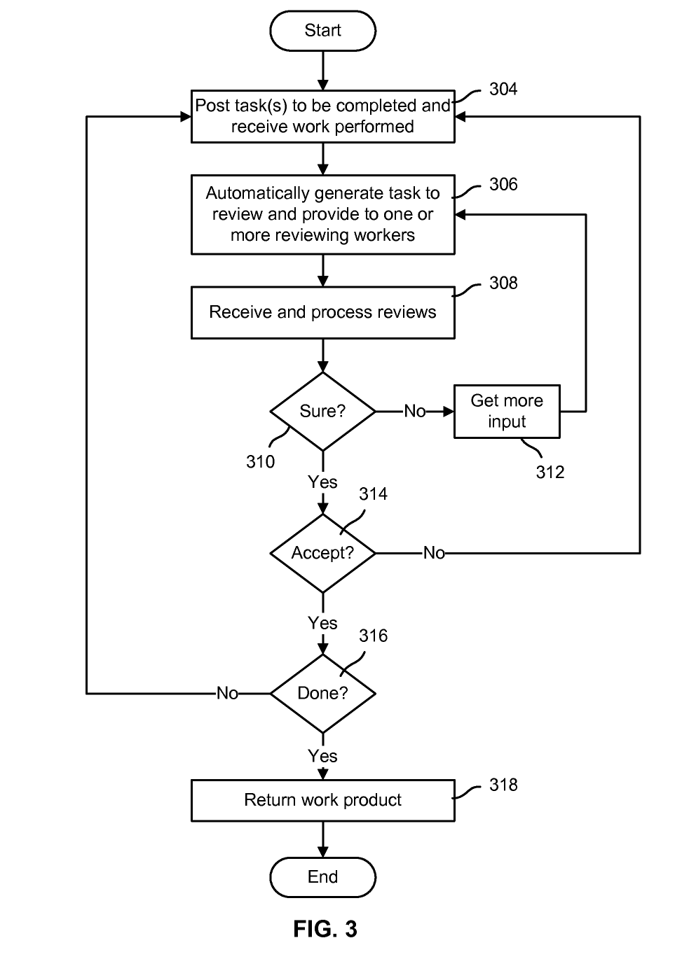

The business process flow instance receives and processes input received from the work requestor to enable the work to be performed (206). Examples include without limitation a document or other content to be edited; text to be translated; and information obtained from the work requestor to be used to create content, such as a press release. The input data is processed into a format and/or unit size indicated by the business process flow as being required to complete the work. For example, text to be edited may be divided up into pages or other subdivisions of a prescribed unit size, to enable the work completion platform to assign each page separately to be edited in parallel. Or, input data provided by a work requestor may be parsed and reformatted for consumption by the work completion platform, such as xml or other structured data. The processed input data is provided to a work completion platform to cause specific work to be done, for example by calling an “edit” or other service of the work completion platform and providing the respective pages of input as objects on which the “edit” work is to be performed (208). The business process flow instance enters a waiting state while the work completion platform causes the work to be performed, in some embodiments as described below in connection with FIG. 3. The business process flow receives the completed work from the work completion platform, such as the edited pages in the example mentioned above, and assembles and delivers to the work requestor the final work product (210).

FIG. 3 is a flow diagram illustrating an embodiment of a process to outsource tasks. In various embodiments, the process of FIG. 3 is implemented by a worker-facing work completion platform of an online outsourcing service such as service 114 of FIG. 1. In the example shown, upon receiving from a business process flow a request to perform specific work the business process flow instance has been created to cause to be performed, one or more discrete tasks required to complete the work are made available to workers to perform, and as each task is completed the work product created by the worker who completed the task is received (304). In some embodiments, workers earn credentials and/or levels of credential by passing a qualifying test. A task may indicate a credential and/or level that a worker must have to be eligible to perform the task. A task may also indicate a minimum applicable reputation score, required demographic and/or psychographic status, etc. required to be eligible to perform the task. The task is only visible in some embodiments to workers eligible to perform the task. In some embodiments, tasks a worker is not (yet) eligible to perform may be shown to a worker but in another color or with some other visual indication that the worker is not eligible to perform that task, for example to induce the worker to aspire to achieve a higher level of credential.

Upon completion of a task, one or more corresponding review tasks are generated automatically (306). The respective results of the review tasks are received and processed (308). If based on the review results received so far a decision cannot be made automatically with a sufficient degree of confidence that the work should be accepted or, conversely, rejected, then more input is obtained (312). In various embodiments work on the work completion platform side is managed by a workflow configured to use an escalation strategy to be able to determine with a sufficient degree of confidence that the original work should be accepted or, conversely rejected. For example, depending on the nature of the work and how the applicable workflow has been configured, one or more additional tasks to obtain further review may be generated, or in a case in which uncertainty persists beyond a configured number of iterations, human intervention by a supervisory staff may be requested. The required degree of certainty may vary depending on factors such as the nature of the task, the sensitivity of a particular work request, for example as indicated by the requestor in the request, and/or the configured and/or indicated preferences of the work requestor.

Once a result (e.g., accept or reject) is determined with the requisite level of certainty (310), if the work was rejected then the original task is resubmitted for completion by another worker, and the task completion and review processing described above is repeated. In some embodiments, the originating worker is not paid and the originating worker's reputation is downgraded if work is rejected. The task and review cycle is repeated until the work produced is accepted. In some embodiments, timeouts or other events may trigger human intervention and/or other exception handling, for example if a task has not been completed within a prescribed time and/or within a prescribed number of attempts.

If the decision is to accept (314), then the original task is completed, and the originating and/or reviewing workers who performed their tasks correctly are paid. If other tasks remain to be performed (316), those tasks are created and caused to be performed (304, etc.). Certain tasks may have dependencies on other tasks and cannot be posted until the tasks on which they depend have been completed. For example, a review task may not be generated and/or posted until a task to generate the work that is to be reviewed has been completed. Upon submission of work product for the original task, one or more review tasks are created and the work produced by the originating worker, or a portion thereof, may be associated with the review tasks as input. Likewise, a task to edit the work product produced by one or more human and/or machine translators cannot be performed until the translation work has been completed. Conversely, an original task cannot move to completion until required review tasks have been completed and processed.

Once all tasks have been completed (316) the work produced is returned (318), for example to the business process flow that invoked the work completion platform, and the process of FIG. 3 ends.

While in the example shown in FIGS. 2 and 3 separate workflows are implemented by different platforms to receive and respond to a work request (FIG. 2) and to cause required work to be completed (FIG. 3), in other embodiments a single platform and business process flow processes and respond to a work request, including by receiving and processing the work request as in FIG. 2 and causing required work to be performed as in FIG. 3.

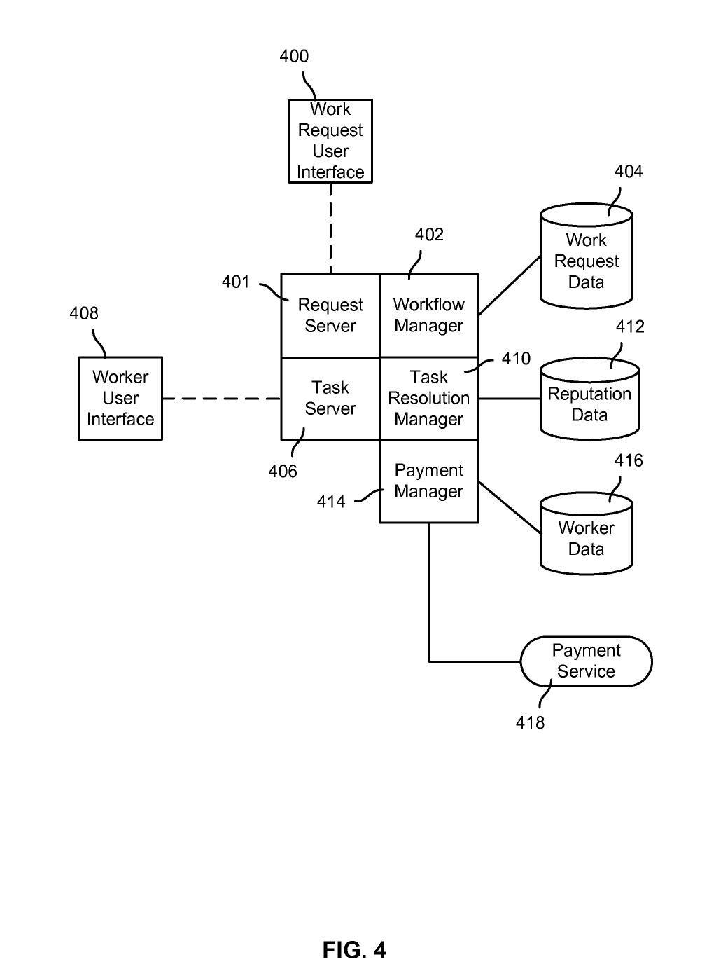

FIG. 4 is a block diagram illustrating an embodiment of a work completion system. In the example shown, a work request user interface 400 is provided to enable work requestors to submit work requests to a request processing server 401. Work requests are fulfilled by a workflow manager 402 configured to manage a business process or other workflow to complete requested work. Work requests and associated data are stored in a work request data store 404. Workflow manager 402 invokes an internal or external work completion function associated with a task server 406. A work completion workflow generates component tasks which are made available to workers via a task server 406. Workers use a worker user interface 408, for example a website, web or mobile application, social network application, etc., to view and select tasks posted by task server 406. Upon completion of a task, work is submitted by originating workers to the task server to be evaluated for acceptance by a task resolution module 410. In some embodiments, an original task and associated review tasks are processed as a task family of related tasks. Task resolution manager 410 evaluates the work performed by the originating worker based at least in part on the reviews performed by reviewing workers who completed the review tasks in the task family. In the example shown, reputation data stored in reputation data store 412 is used to evaluate the work performed. If the work is accepted, a payment manager 414 uses worker data stored in a worker data store 416 and a payment service 418, such as Paypal or another online and/or micropayment service, to pay the originating worker and/or the reviewers whose work was accepted.

In various embodiments, techniques described herein are used to perform various types of work, including without limitation editing content (e.g., proofreading), creating content, translating or otherwise transforming content, and/or more complicated work involving as subcomponents elements of some or all of the above types of work.

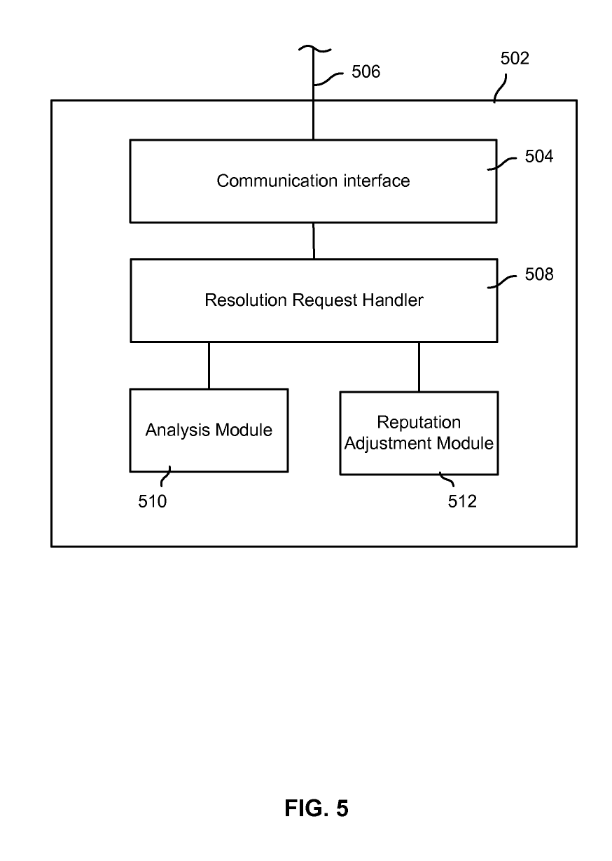

FIG. 5 is a block diagram illustrating an embodiment of a reputation system to evaluate work. In some embodiments, a task resolution module of an outsourcing system, such as task resolution module 410 of FIG. 4, sends the work produced by an originating worker, the results of associated review tasks, and reputation data of the originating and review workers to a reputation system such as reputation system 502 of FIG. 5. In the example shown, the reputation system 502 includes a communication interface 504 and a network connection 506 via which the reputation system 502 can receive network communications. A resolution request handler 508 responds to received resolution requests by passing task work product and review results to a work acceptability analysis module 510, which is configured to determine, based at least in part on the received results and the respective reputation data of the originating and reviewing workers, which workers performed quality work.

While in some embodiments described herein the work product that the review results or other result data relates to is an original work product produced by an originating worker, such as an outsource worker, the reputation system disclosed herein may be used to process any result data, generated by any worker, that reflects on the quality of a given work product. The work product may be produced by an originating human worker, a machine, or a combination thereof

Once the result of the analysis module 510 is known, reputation adjustment module 512 uses the results to compute amounts by which the respective reputations of the originating worker and reviewing workers should be adjusted. For example, if the originating task is determined to have been performed accurately, based on two reviews indicating agreement with the originating worker's result and one review expressing disagreement, then a small upward adjustment may be determined for the originating worker and the two reviewers who agreed that the originating worker performed the task accurately and a larger downward adjustment may be made to the dissenting reviewer's reputation. In some embodiments, the magnitude of the adjustments may be determined at least in part on factors such as the respective reputations of the reviewers and/or the originating worker prior to the current task family being evaluated, how certain the reputation system is of the determination as to which workers were right and which were wrong, and recent historical trends and/or adjustments to the respective workers' reputations with respect to other work they have performed. In some embodiments adjustments are made such that it takes a worker a long time to build up a reputation relative to the time it takes to lose or damage his/her reputation, for example through clearly and/or consistently inaccurate work. In some embodiments, separate reputation scores or other values are maintained for different qualifications and/or levels, and the reputation system computes adjustment amounts that affect only the reputation score(s) relevant to a particular task. The results determined by the reputation system 502 (i.e., which workers are right, degree of certainty, and respective reputation adjustment amounts) are returned to the outsourcing system, which stores reputation updates and initiates payment transactions for workers determined to have performed their task accurately.

In various embodiments, a reputation score or other reputation data as described herein comprises a single, composite score that reflects and embodies both a current reputation level of the worker (originating or reviewing worker) and at least in part a reputation history of the worker. The score reflects how the worker's reputation has changed over time, including whether the score has increased consistently over a long or short period of time, whether and by how much the score has increased or decrease in recent times, etc. The reputation score is based in various embodiments at least in substantial part on actual judgments by other workers, conducted without knowledge of the identity of the worker whose work they are reviewing, of work produced by the worker; and/or on whether other workers agreed or disagreed with a judgment or decision of the worker, such as an indication by the worker in a reviewer role that reviewed work should be accepted or rejected. The reputation score, therefore, reflects the collective judgment of others, over time, as to the quality of the worker's work. The approach described herein differs from rating systems, in which users provide star, numerical, or other ratings to other users. Ratings provided in such systems may be based on considerations other than an objective assessment of the quality of the rated user's work. Ratings for a user typically are not determined based on blind review by others of specific work product of the user. By comparison, in the approach described herein, a worker's reputation score is based largely on the ideally blind review (i.e., not knowing the identity of the originating worker) of the work output produced by the worker over time. Moreover, the judgments by reviewing workers are made in the context of a review task in which the reviewer is motivated by self-interest—such as the desire to be compensated for producing a correct answer and to protect his/her own reputation by producing a correct answer—to provide a correct, unbiased response. The reputation score determined as described herein reflects, therefore, the human experience by which reputation is built or lost, such as the collective judgment by qualified peers as to whether or not the worker produces quality work. In addition, in various embodiments a reputation score rises slowly through consistently performed acceptable work, but can decrease by larger increments if work quality suddenly or dramatically declines, as is common in human experience as well.

Other factors reflected in a reputation score in various embodiments, and/or otherwise considered by the reputation system described herein, include how long the worker has been a member of the worker pool (how much history) and in some embodiments other data such as demographic, psychographic, and other data associated with the worker.

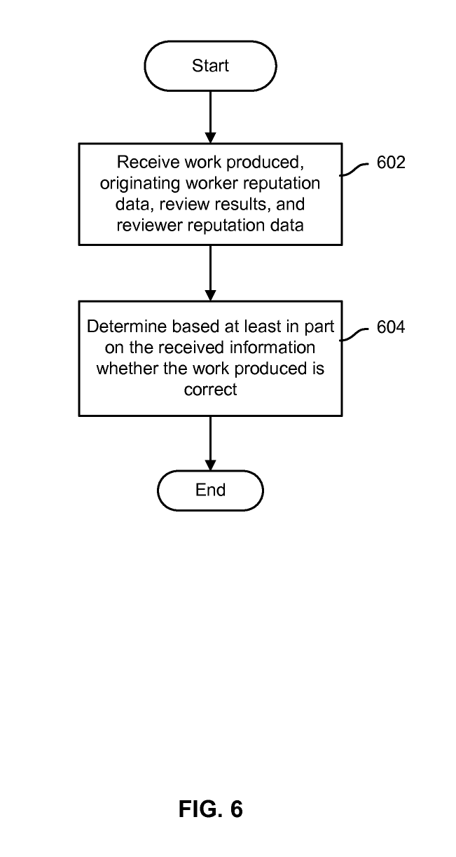

FIG. 6 is a flow diagram illustrating an embodiment of a process to evaluate work. In various embodiments, the process of FIG. 6 is implemented by a reputation system such as reputation system 502 of FIG. 5. In the example shown, work produced by an originating worker, the originating worker's reputation score or other data as relevant to the task, the results of one or more review tasks, and the respective reputation data of the reviewers are received (602). The received data is used to determine which answers (originating worker's work product, reviewers' answers to review tasks questions) are correct. For example, in some embodiments, the reviewer's respective judgments regarding the accuracy of the originating worker's work may be weighted to reflect the reviewer's respective reputations and the weighted judgments compared to determine which reviewer answers are correct. A favorable review from a reviewer with a strong reputation (as indicated by a reputation score or other received reputation data that reflects other's judgment over time of work performed by the reviewer and/or agreement with review or other determinations made by the reviewer) in some embodiments and circumstances might trump unfavorable (or less favorable) reviews by two other reviewers with lower reputation scores. Conversely, a negative review by a reviewer with a very high reputation score might trump more favorable reviews from other reviewers with lower scores.

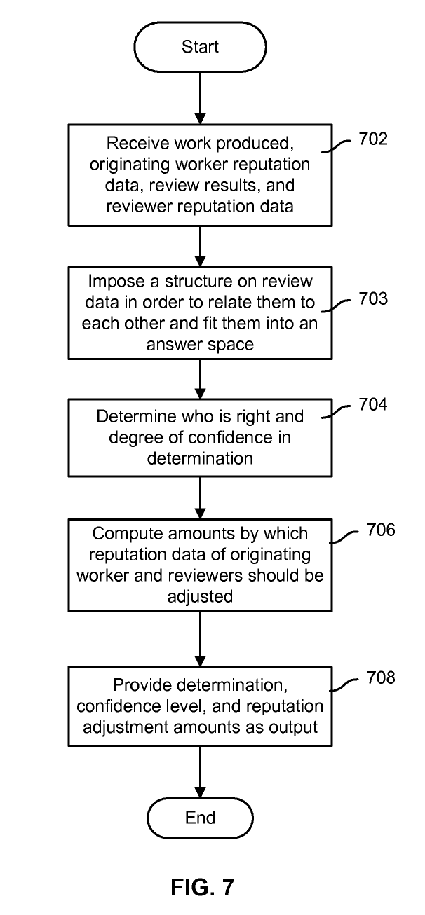

FIG. 7 is a flow diagram illustrating an embodiment of a process to evaluate quality. In some embodiments, the process of FIG. 7 is used to evaluate the quality of work. In the example shown, work produced by an originating worker, the originating worker's reputation score or other data as relevant to the task, the results of one or more review tasks, and the respective reputation data of the reviewers are received (702). In some embodiments, review task results comprise answers in the form of key-value pairs. The respective reviewers' answer sets are compared to determine which answers are related, e.g., which have the same key. The answers are further processed by imposing on the answer data a structure in order to relate different answer values to each other and to understand how answers fit into an answer space (703). In various embodiments, a map or other structure or technique is used to impose structure. A value included with the review result data as received by the reputation system indicates a type of map to be applied. Examples include without limitation a bias map (answer space is a spectrum or range of subjective evaluations, such as “awful”, “bad”, “okay”, “good”, “very good”), a letter map (unrelated independent answer choices “A”, “B”, “C”, “D”, or “E”), and a binary map (0 or 1, up or down, correct or wrong, etc.) The imposition of structure in this way allows arbitrary answer values to be evaluated to determine which answers are correct, without having to program or otherwise build into the reputation system an understanding of the semantics of the answer values themselves. For example, use of a bias map may result in relatively closely related answers such as “good” and “very good” to be related and processed in a way (for example, combined into a single value) that is different than arbitrary and unrelated responses that might happen to be associated with adjacent answer choices in a multiple choice question. The received data is used to determine which review answers are right and how confident the system is in its determination (704). For example, originating work judged to be accurate by every reviewer assigned to review the original work may be judged to be accurate with higher confidence than if one reviewer reached a different conclusion. Also, the degree of confidence in a determination that work was or was not performed accurately may be higher, all else being equal, if the reviewers have higher relevant reputation scores. In some embodiments, an overall grade for each originating and review task is generated, and a degree of confidence in the overall grade is computed. Based at least in part on the determined results, the reputation system computes amounts by which the respective workers' reputation scores or other values should be adjusted (706). For example, if the system determined that the originating worker's work was accurate, then the originating worker's reputation and those of reviewers who agreed that the originating worker produced quality work would be adjusted upward, and a dissenting reviewer's reputation score, if any, would be adjusted downward. The determination of which workers were right (e.g., overall task grade based on correct answer determinations indicates worker performed task correctly), respective confidence levels, and reputation adjustments are provided as output (708). In some alternative embodiments, only an indication of which workers were right, or only an indication of which answers were determined to be right, is provided as output.

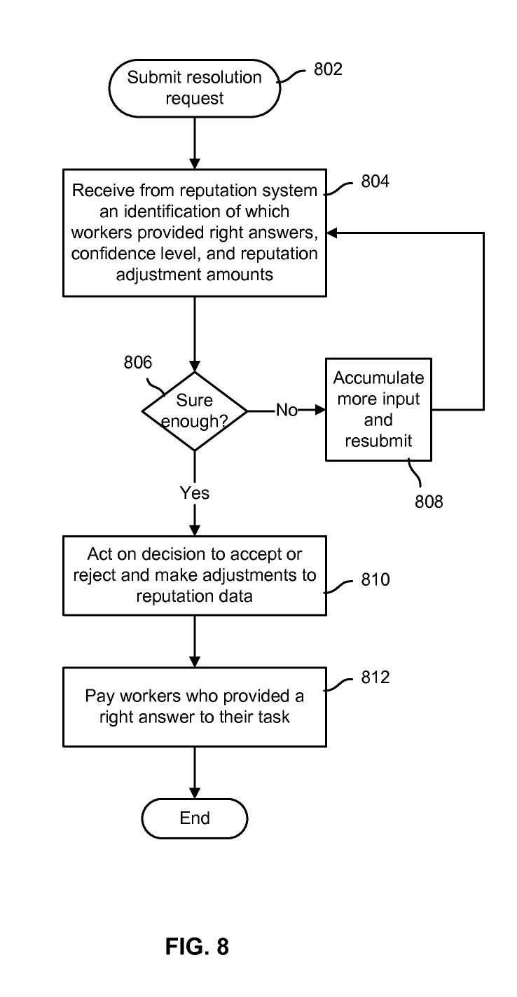

FIG. 8 is a flow diagram illustrating an embodiment of a process to evaluate work. In various embodiments, the process of FIG. 8 is implemented by a component configured to use a reputation system as described herein to determine a resolution for a family of tasks, specifically whether to accept work product, and to implement reputation adjustments indicated by the reputation system where appropriate. In the example shown, a resolution request is sent to the reputation system, comprising a work produced in an original task, one or more reviews, and reputation data for the originating and reviewing workers (802). A response is received from the reputation system, the response indicating which workers performed their task correctly, a degree of confidence by the reputation system in its determination, and amounts by which the respective reputation scores of the affected workers should be adjusted based on the reputation system's determination (804). If a required degree of confidence prescribed for the task has not been achieved (806), more input is obtained (808), for example by causing additional review tasks to be generated to be performed by additional reviewers, possibly requiring a higher level of reviewer skill. In some embodiments, a task family that cannot be resolved may be sidelined and the original task caused to be redone by another. Once additional input is received the augmented data is submitted to the reputation system to determine which workers performed their task accurately and for each determination a computed degree of confidence that the determination is correct (804). Once an accuracy determination is made with the required degree of confidence (806), the outsourcing system acts on the determination, i.e., the original task is either accepted or rejected depending on what the reputation system determined and/or other acceptance criteria, and the reputation scores of the affected workers are adjusted by the amounts indicated by the reputation system (810) and workers who provided a right answer are paid (812).

In some embodiments, resolution requests received by the reputation system include state information that reflects a starting state of the inputs to the reputations system in the context of a global system in which multiple work flows and associated task families and resolution requests may be running in parallel. The reputation system includes the state information in the resolution results it returns as output. The resolution requestor, such as the task resolution module described above, uses the state information to determine whether to process the reputation system's output. If the state information in the response from the reputation system is not consistent with current state information of the task resolution module and/or other components, then the state information is updated and the resolution request resubmitted with updated state information. For example, resolution result data received in response to another resolution request involving one or more overlapping workers may have resulted in a current reputation score of a worker having been changed in the time between submission of the current resolution request and receipt of a response. In some embodiments, resolution requests and responses include a starting reputation score and a proposed adjusted score. If by the time the resolution request response is received the current reputation score does not match the starting reputation score indicated in the response, the resolution request is resubmitted with the starting reputation score updated to reflect the current score.

An administrator may intervene to adjust the outcome of a particular resolution request, resulting in a different resolution system output for the task family, including different reputation score adjustments. In some embodiments, task families that were resolved subsequent to the modified resolution are re-run with the modified resolution as a new starting point, which in turn may require other task resolutions to be re-run to reflect changes to historical reputation scores of participating workers and/or work product owners. In some embodiments, historical information regarding which resolution algorithms, etc. were used for specific tasks or types of task over time is used to ensure that the same approach is used to re-run resolution of a task family as was applied in the original resolution.

While in certain embodiments a task by an originating work and work produced in response to such a task are described, techniques disclosed herein are applied in other embodiments to other types of work product, including without limitation work product in whole or in part by a machine. Examples include content translated at least initially by a machine and/or search engine results. In the later case, for example, “reviewing” workers may be asked to judge whether search results generated in response to a query were useful.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A reputation system to evaluate work product, comprising:
a communication interface coupled to receive answer data for each of one or more unsupervised workers, the answer data comprising one or more answers each representing a judgment by the worker that reflects on the quality of a given work product; and
a processor configured to determine, based at least in part on a reputation data of an owner of the work product, the answer data, and a respective reputation data of the respective unsupervised workers, which answers are correct.

2. The system of claim 1, wherein the reputation data comprises a reputation score.

3. The system of claim 2, wherein the reputation score comprises a composite score that reflects both a current reputation and a reputation history of the worker.

4. The system of claim 1, wherein the owner of the work product comprises an originating unsupervised worker who created the work product.

5. The system of claim 4, wherein the originating unsupervised worker created the work is product in connection with performing an outsourced task.

6. The system of claim 5, wherein the answer data is generated at least in part by providing to the unsupervised workers who provided the answer data an outsourced task to review the work product produced by the originating worker.

7. The system of claim 1, wherein owner of the work product comprises a machine that generated the work product.

8. The system of claim 1, wherein the processor is configured to compute a degree of confidence in the determination of which answers are correct.

9. The system of claim 8, wherein the degree of confidence is based at least in part on one or both of the reputation data of the work product owner and the respective reputation data of the unsupervised workers who provided the answers.

10. The system of claim 1, wherein the processor is configured to compute based at least in part on the determination which answers are correct an amount by which the reputation data of the work product owner should be adjusted.

11. The system of claim 10, wherein the absolute value of the amount by which the reputation data of the work product owner is computed to be adjusted is larger if the answers determined to be correct indicate the work product was not quality work than if the answers determined to be correct indicate the work product was quality work.

12. The system of claim 1, wherein the processor is configured to compute based at least in part on the determination which answers are correct an amount by which the reputation data of the unsupervised workers should be adjusted.

13. The system of claim 1, wherein the reputation data of the work product owner comprises a reputation data associated with a credential with which the work product is associated.

14. The system of claim 13, wherein the credential comprises a credential the originating worker was required to possess to be eligible to perform a task in response to which the work is output was produced.

15. The system of claim 13, wherein the credential is associated with one or more of a skill set, an expertise, a professional certification or license, and a specialized knowledge associated with the work product owner.

16. The system of claim 1, wherein the determination which answers are correct is based at least in part on the work product.

17. The system of claim 1, wherein one or more of the answers, the work product owner reputation data, and the worker reputation data are received via the communication interface from an external system.

18. The system of claim 1, wherein one or more of the answer data, the work product owner reputation data, and the worker reputation data are received via the communication interface from a third party system.

19. The system of claim 1, wherein the processor is further configured to send via the communication interface a responsive communication that reflects an outcome of the determination of which answers are correct.

20. The system of claim 1, wherein the answer data comprises semi-structured data and the processor is configured to determine which answers are correct at least in part by imposing on the answer data a structure that indicates how different answers to the same question related to each other in the context of an applicable answer space.

21. The system of claim 1, wherein the reputation system is configured to receive state information indicating a starting state of the inputs provided to the reputation system.

22. The system of claim 21, wherein the reputation system is configured to include the state information in an output generated based at least in part on the determination as to which answers are correct.

23. The system of claim 22, wherein the original input data is updated with current state and resubmitted to the reputation system in the event the state information included in the reputation is system output is determined not to match a corresponding current state information.

24. A method to evaluate work product, comprising:
receiving via a communication interface answer data for each of one or more unsupervised workers, the answer data comprising one or more answers each representing a judgment by the worker that reflects on the quality of a given work product; and
determining programmatically based at least in part on a reputation data of an owner of the work product, the answer data, and a respective reputation data of the respective unsupervised workers, which answers are correct.

25. The method of claim 24, wherein the reputation data comprises a reputation score.

26. The method of claim 25, wherein the reputation score comprises a composite score that reflects both a current reputation and a reputation history of the worker.

27. The method of claim 24, wherein the owner of the work product comprises an originating unsupervised worker who created the work product.

28. The method of claim 27, wherein the originating unsupervised worker created the work product in connection with performing an outsourced task.

29. The method of claim 28, wherein the answer data is generated at least in part by providing to the unsupervised workers who provided the answer data an outsourced task to review the work product produced by the originating worker.

30. A computer program product to evaluate work product, the computer program product being embodied in a tangible, non-transitory computer readable storage medium and comprising computer instructions for:
receiving answer data for each of one or more unsupervised workers, the answer data comprising one or more answers each representing a judgment by the worker that reflects on the quality of a given work product; and
determining based at least in part on a reputation data of an owner of the work product, the answer data, and a respective reputation data of the respective unsupervised workers, which answers are correct.
